(19) United States
(12) Patent Application Publication
(10) Pub. No.: US 2026/0128460 A1
(43) Pub. Date: May 7, 2026

(54) CATALYST-COATED MEMBRANE FOR GAS REACTION AND MANUFACTURING METHOD THEREOF

(71) Applicant: TAIWAN CARBON NANO TECHNOLOGY CORPORATION, Miaoli County (TW)

(72) Inventors: Kuang-Che Lee, Miaoli County (TW); Chia-Hung Li, Miaoli County (TW); Chun-Hsien Tsai, Miaoli County (TW)

(21) Appl. No.: 18/940,098

(22) Filed: Nov. 7, 2024

(51) Int. Cl. H01M 50/403; C25B 1/04; C25B 13/08; H01M 50/414; H01M 50/457; H01M 50/489

(52) U.S. Cl. CPC H01M 50/403; C25B 13/08; H01M 50/414; H01M 50/457; H01M 50/489; C25B 1/04

(57) ABSTRACT

The present invention involves a method for manufacturing a catalyst-coated membrane (CCM) for a gas reaction and the manufactured CCM. The method comprises steps of providing a first substrate having a first surface; forming a first catalyst on the first surface of the first substrate layer; providing a second substrate with a friction coefficient on the first catalyst layer, the friction coefficient ranging from 2 to 15; and laminating the first catalyst layer onto the second substrate with a membrane pressure to form the catalyst-coated membrane, wherein the membrane pressure ranges greater than 0 Kgf/cm² and less than or equal to 380 Kgf/cm².

### FIELD OF THE INVENTION

The present invention relates to a catalyst-coated membrane for a gas reaction and a manufacturing method thereof, and in particular to a catalyst-coated membrane including a high friction coefficient substrate and a manufacturing method thereof.

### BACKGROUND OF THE INVENTION

Catalyst-coated membranes (CCMs) can promote the occurrence of electrochemical reactions and are currently widely used in technical fields such as electrolysis of water to produce hydrogen or oxygen, carbon dioxide reduction, gas sensors, and fuel cells. At present, the manufacturing methods of CCMs mainly include direct coating methods and transfer printing methods.

The transfer printing methods comprise first applying catalyst slurry to a surface of a transfer medium, heating it to remove the solvent to form a catalyst layer, and then transferring the catalyst layer to a proton exchange membrane through a hot pressing process. The transfer printing methods may have the following shortcomings: the process is complex and the manufacturing cost is high; during the hot pressing process for transferring the catalyst layer, the contact between the catalyst layer and the proton exchange membrane is difficult to control, and the membrane may be easily damaged if the contact edge between the membrane and the transfer medium is unevenly pressed; during the transfer process, due to incomplete transfer, parts of the catalyst may remain on the transfer medium, resulting in a decrease in catalyst utilization; and the transfer medium is easily damaged after repeatedly being used in the hot pressing process, which precludes the transfer medium from being reused and thus increases manufacturing costs.

The direct coating methods use a large amount of solvent to prepare a catalyst slurry, and then the catalyst slurry is directly coated on the proton exchange membrane. In this way, the catalyst layer and the proton exchange membrane can be in close contact, thereby achieving better performance of CCMs. Compared with the transfer printing methods, the direct coating methods have a simple process, and because the catalyst layer and the proton exchange membrane can be in close contact, the CCMs produced thereby can achieve better performances. However, the proton exchange membrane on which the catalyst slurry is coated is an extremely thin flexible membrane (for example, the thickness of Nafion 212 and that of Nafion 211 are only about 50 microns and 25 microns respectively), and thus it is difficult to fix and flatten the proton exchange membrane when applying catalyst slurry thereon. For the existing technologies, the membrane is usually laid flatly on a flat substrate, and then the catalyst is manually brushed onto the membrane. This method is very inefficient. For other more efficient direct coating methods (such as the roll-to-roll (R2R) coating method), in order to firmly fix the proton exchange membrane, the proton exchange membrane is usually fixed by suction (for example, through the multiple suction holes on a stage, the proton exchange membrane is firmly attached to the surface of the stage under negative pressure (or vacuum)) to perform the coating process. In order to prevent the proton exchange membrane from moving by force applied during the direct coating procedure, a suction with a sufficient negative pressure (or vacuum) must be supplied. However, such negative pressure suction can easily cause wrinkles or deformation of extremely thin membranes. In addition, the proton exchange membrane is easily deformed when exposed to moisture and alcohol solvents. In severe cases, the catalyst layer around the deformed area will peel off, which reduces the utilization and performance of the catalyst. Because the catalyst slurry usually contains solvents such as water and ethanol, the membrane may easily become uneven during the direct coating process, and thus it is difficult to obtain an uniform CCM. In order to overcome this problem, the catalyst layers on the first and second sides can be prepared by the direct coating process and the transfer printing process respectively, or a solvent removal process can be added to the manufacturing process. However, these methods will make the manufacturing process more complex and reduce production efficiency.

Based on the above, the problems of surface unevenness and membrane deformation of CCM have become a major obstacle to the CCM manufacturing methods. Therefore, in this field, there is a need of a CCM and its manufacturing method without the problems of surface unevenness and membrane deformation.

Therefore, in view of the deficiencies in the prior art, the applicants of the present application developed the present invention “catalyst-coated membrane for a gas reaction and its manufacturing method” to overcome the disadvantages of conventional technologies. The descriptions of the present invention are as follows:

### SUMMARY OF EXEMPLARY EMBODIMENTS

The purpose of the present invention is to provide a CCM and a manufacturing method thereof that can overcome the problems of surface unevenness and membrane deformation of the CCM. This method can prepare CCM with high efficiency, and can avoid problems such as deformation, swelling, catalyst layer detachment, and catalyst layer cracks in the produced CCM. In other words, the CCM manufactured by the method of the present invention has high surface flatness and high uniformity, which greatly increases the yield of the CCM process and reduces the cost.

In one aspect, the present invention provides a method for manufacturing a catalyst-coated membrane for a gas reaction. The method comprises steps of providing a first substrate having a first surface; forming a first catalyst on the first surface of the first substrate layer; providing a second substrate with a friction coefficient on the first catalyst layer, the friction coefficient ranging from 2 to 15; and laminating the first catalyst layer onto the second substrate with a membrane pressure to form the catalyst-coated membrane, wherein the membrane pressure ranges greater than 0 Kgf/cm² and less than or equal to 380 Kgf/cm².

In another aspect, the present invention provides a method for manufacturing a catalyst-coated membrane for a gas reaction. The method comprises steps of providing a sandwich structure including a first substrate, a second substrate and a first catalyst layer sandwiched between the first substrate and the second substrate, wherein the second substrate has a friction coefficient ranging from 2 to 15; and laminating the sandwich structure together with a pressure ranging greater than 0 Kgf/cm² and less than or equal to 380 Kgf/cm².

In another aspect, the present invention provides a catalyst coating method for a gas reaction. The method comprises steps of providing a substrate having a first surface and a second surface with a first protective film and a second protective film thereon for protecting the first surface and the second surface respectively; removing the first protective film; coating a first catalyst layer on the first surface; covering the first catalyst layer with a new protective layer to replace the first protective film; removing the second protective film; and coating a second catalyst layer on the second surface.

In another aspect, the present invention provides a catalyst-coated membrane for a gas reaction. The catalyst-coated membrane comprises a first substrate; a second substrate having a friction coefficient in a range of 2 to 15 and including a polymer; and a catalyst layer sandwiched between the first substrate and the second substrate. Preferably, the polymer comprises at least one of a silicone, a rubber and a silicone rubber.

### BRIEF DESCRIPTION OF THE DRAWINGS

The embodiments and advantages of the present invention will become more readily apparent to those ordinarily skilled in the art after reviewing the following detailed descriptions and accompanying drawings.

FIG. 1 shows a flow chart of a method for manufacturing a catalyst-coated membrane (CCM) for a gas reaction according to the present invention.

FIG. 2A shows a single-sided CCM made according to the manufacturing methods of the present invention.

FIG. 2B shows a double-sided CCM made according to the manufacturing methods of the present invention.

FIG. 3 shows the influence of different static friction coefficients of the second substrate samples 1 to 5 on the surface flatness of the CCMs in the embodiments 1 to 5.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

Unless otherwise limited or described in a specific example, the following definitions apply to terms used throughout this specification.

The term “comprising” or “including” as used herein means that in addition to the described components, steps, and/or elements, the presence of one or more other components, steps, and/or elements is not excluded.

The term “about” as used herein means there is a close or allowable error range to prevent the present invention from being limited to the exact or absolute numerical values disclosed. The term “a” used herein means that the object of the article is one or more than one.

The term “single-sided CCM”, “single-side catalyst-coated membrane” or “single-side catalyst-coated CCM” as used herein refers to a catalyst-coated membrane (CCM) made by a single-sided coating method and having a catalyst layer covered on only one of the two opposite surfaces of the CCM.

The term “double-sided CCM”, “double-side catalyst-coated membrane” or “double-side catalyst-coated CCM” as used herein refers to a catalyst-coated membrane (CCM) made by a double-sided coating method and having catalyst layers covered on both opposite surfaces of the CCM.

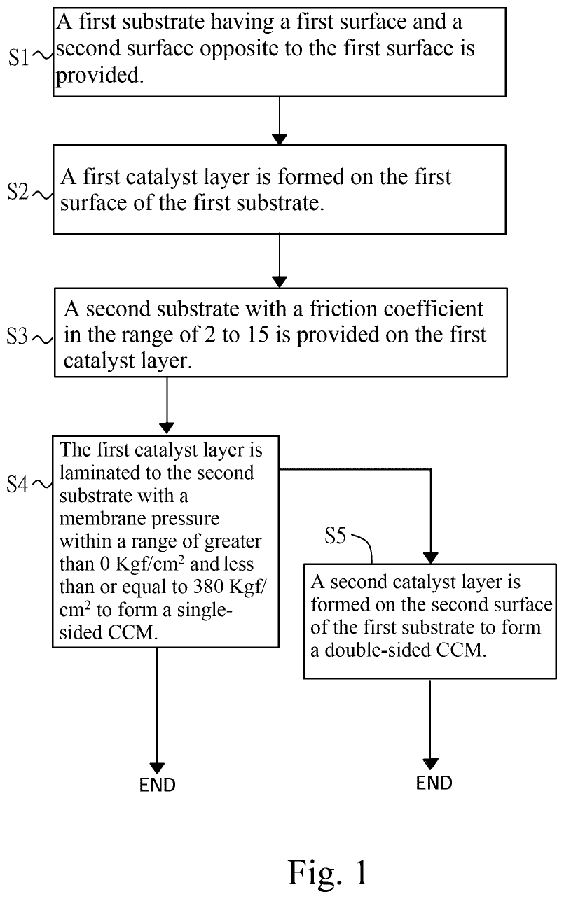

Please refer to FIG. 1, which shows a flow chart of a method for manufacturing a catalyst-coated membrane (CCM) for a gas reaction according to the present invention. As shown in this figure, the method may comprise the following steps.

Step S1: a first substrate having a first surface and a second surface opposite to the first surface is provided. In some embodiments, the first substrate is a polymer membrane, such as a perfluorosulfonic acid polymer membrane. In some embodiments, the first substrate is an electrolyte membrane (also called a proton exchange membrane or an ion exchange membrane), such as a cation exchange membrane, an anion exchange membrane, a perfluorosulfonic acid ion exchange membrane, Nafion 212, Nafion 117, Nafion 119, Nafion 211, etc. The electrolyte membranes with the aforementioned model numbers all have different thicknesses. Taking Nafion 212 as an example, its thickness is about 50.8 microns. In view of the extremely thin thickness of the first substrate, in some embodiments, there are a first protective film (also called a cover film) and a second protective film (also called a bottom film) that respectively protect the first surface and the second surface. In some embodiments, the first substrate has the first protective film and the second protective film. The cover film and the bottom film can be, for example, thin plastic films. When the cover film is removed, the first surface of the first substrate will be exposed, and when the bottom film is removed, the second surface of the first substrate will be exposed.

Step S2: a first catalyst layer is formed on the first surface of the first substrate. In some embodiments, the aforementioned formation of the first catalyst layer is achieved by a direct coating method. The “direct coating method” means that the first catalyst layer is directly coated or formed on the first surface, rather than through, for example, using a transfer method or other indirect methods to form the first catalyst layer elsewhere and then transferring the formed first catalyst layer to the first surface of the first substrate. In some embodiments, the methods of forming the first catalyst layer include but are not limited to a roll-to-roll (R2R) coating method, a brush coating method, an ultrasonic coating method, a scrape coating method, a transfer printing method, or a screen printing method. In an embodiment in which the first substrate has a cover film and a bottom film, the step S2 comprises removing the cover film on the first surface to expose the first surface of the first substrate so as to form a first catalyst layer on the first surface. Although the thickness of the first substrate is extremely thin, because the bottom film can support and hold the first substrate with the first surface exposed, not only is the first substrate not easily deformed or wrinkled or swollen during the step S2, but also the formed first catalyst layer has a flat and crease-free surface. The thickness range of the first catalyst layer depends on the method used to form the first catalyst layer. For example, when a scrape coating method is used, the formed first catalyst layer preferably has a thickness in a range of about 15 to 80 μm.

In some embodiments, the step S2 specifically comprises: heating the first substrate to a coating temperature; supplying and coating a first catalyst layer slurry on the first surface of the first substrate at the coating temperature to form the first catalyst layer on the first surface; and drying the formed first catalyst layer. During the coating process, the temperature is first raised to the coating temperature before the first catalyst layer is coated, which helps to make the first catalyst layer have a flat surface. The first catalyst layer slurry may contain about 20 wt % to 70 wt % catalyst, an appropriate amount of a binder and an appropriate amount of a dispersant. The catalyst includes at least one of Pt, Ru, Ir, Au, Ni, Co, Zn, Ag and alloys or oxides thereof. For example, the catalyst materials in the first catalyst layer may include Pt/C, PtRu/C, Ru/C, IrO₂ or other noble metals and metal oxides. The binder may be, for example, perfluorosulfonic acid resin. The dispersant may be water or alcohol, such as at least one of methanol, ethanol, isopropyl alcohol, n-propanol and n-butanol. The temperature used to dry the first catalyst layer depends on the composition of the first catalyst layer. For example, the drying temperature for the first catalyst layer may be in a range between about 70° C. and about 150° C.

Step S3: a second substrate with a friction coefficient is provided on the first catalyst layer, wherein the friction coefficient is in the range of 2 to 15. The friction coefficient is the static friction coefficient defined according to the international standard ASTM D1894. The ASTM D1894 describes a standard test method for testing the dynamic and static frictional forces generated between overlapping films (the second substrate in the present application) when sliding them over themselves or other materials under specified test conditions, and through the calculations of the results, the static and kinetic friction coefficients of the films (the second substrate in the present application) can be determined. Preferably, the friction coefficient of the second substrate is in a range of 5 to 15, and more preferably, the friction coefficient is in a range of 10 to 15. In some embodiments, the second substrate includes at least one of the following materials silicone, rubber, silicone rubber, and polymer; and preferably, the second substrate includes at least one of the following materials: silicone, rubber and silicone rubber. The experiments of the present invention proved that the friction coefficient of the second substrate is positively correlated with the flatness of the manufactured CCM. Therefore, the material of the second substrate in the present invention may include any material(s) with a friction coefficient in the range of 5 to 15, and is not limited to those mentioned above.

Step S4: the first catalyst layer is laminated to the second substrate with a membrane pressure within a range of greater than 0 Kgf/cm² and less than or equal to 380 Kgf/cm² to form a single-sided CCM. The membrane pressure is a pressure that the membrane(s) is subjected to. Preferably, the membrane pressure is within a range of greater than 0 Kgf/cm² and less than or equal to 50 Kgf/cm²; and more preferably, the membrane pressure is within a range of greater than 0 Kgf/cm² and less than or equal to 10 Kgf/cm². The lamination process can be performed in an atmospheric environment or a vacuum environment, and optionally, the lamination process can be a thermal lamination process or a room temperature lamination process. In this step, the extremely thin first substrate is adhered to the second substrate with a high friction coefficient through the lamination pressure (i.e., the membrane pressure), which can prevent the swelling effect problem on the uneven surface that occurs when CCM is prepared by a direct coating process. The single-sided CCM made in this way has flat surfaces. That is, there is no swelling, creases or deformation on the first substrate or the first catalyst layer.

If a single-sided CCM is to be manufactured, the method for manufacturing a CCM for a gas reaction ends after the step S4. If a double-sided CCM is to be manufactured, step S5 is performed after the step S4.

Step S5: a second catalyst layer is formed on the second surface of the first substrate to form a double-sided CCM. In some embodiments, the formation of the second catalyst layer is performed by a direct coating method. The “direct coating method” means that the second catalyst layer is directly coated or formed on the second surface, rather than through using an indirect method (such as a transfer printing method) to form the second catalyst layer elsewhere and then transferring the formed second catalyst layer to the second surface of the first substrate. In some embodiments, the methods of forming the second catalyst layer include but are not limited to a roll-to-roll (R2R) coating method, a brush coating method, an ultrasonic coating method, a scrape coating method, a transfer printing method, or a screen printing method. In an embodiment in which the first substrate has a cover film and a bottom film, the step S2 comprises removing the bottom film on the second surface to expose the second surface of the first substrate. Although the thickness of the first substrate is extremely thin, because the second substrate with a friction coefficient in a specific range supports and adheres to the first substrate with the second surface exposed, not only is the first substrate not easily deformed, moved or shrunk during the step S5, thereby ensuring that the first substrate is flat when the second catalyst is coated, but the formed second catalyst layer has a flat surface without swelling or creases. The thickness range of the second catalyst layer depends on the method used to form the second catalyst layer. For example, when a scrape coating method is used, the formed second catalyst layer preferably has a thickness in a range of about 15 to 80 μm. In some embodiments, the thickness of the second catalyst layer is the same as the thickness of the first catalyst layer. In some embodiments, the thickness of the second catalyst layer is different from the thickness of the first catalyst layer.

In some embodiments, the step S5 specifically comprises: heating the first substrate to a coating temperature; supplying and coating a second catalyst layer slurry on the second surface of the first substrate at the coating temperature to form the second catalyst layer on the second surface; and drying the formed second catalyst layer. During the coating process, the temperature is first raised to a coating temperature higher than the room temperature before the second catalyst layer is coated, which helps to make the finished second catalyst layer or CCM have a flat surface. The second catalyst layer slurry may contain about 20 wt % to 70 wt % catalyst, an appropriate amount of a binder and an appropriate amount of a dispersant. The catalyst includes at least one of Pt, Ru, Ir, Au, Ni, Co, Zn, Ag and alloys or oxides thereof. For example, the catalyst materials in the second catalyst layer may include Pt/C, PtRu/C, Ru/C, IrO₂ or other noble metals and metal oxides. The binder may be, for example, perfluorosulfonic acid resin. The dispersant may be water or alcohol, such as at least one of methanol, ethanol, isopropyl alcohol, n-propanol and n-butanol. In some embodiments, the composition of the second catalyst layer is the same as the composition of the first catalyst layer. In some embodiments, the composition of the second catalyst layer is different from the composition of the first catalyst layer. The temperature used to dry the second catalyst layer depends on the composition of the second catalyst layer. For example, the drying temperature for the second catalyst layer may be in a range between about 70° C. and about 150° C.

In some embodiments, the catalyst coating method for a gas reaction comprises the following steps. First, a substrate (such as an electrolyte membrane or a polymer membrane) is provided. The substrate has a first surface, a second surface opposing the first surface, a first protective film (e.g., the cover film) for protecting the first surface and a second protective film (e.g., the bottom film) for protecting the second surface. Next, the first protective film (e.g., the cover film) is removed, and the first catalyst layer is coated (e.g., directly coated) on the first surface of the substrate. Then, a new protective layer (such as the second substrate) is covered on the first catalyst layer to replace the first protective film so as to form a single-sided CCM. The new protective layer has a friction coefficient in a range of 2 to 15, preferably in a range of 5 to 15, and more preferably in a range of 10 to 15, so as to support and protect the substrate. The friction coefficient above preferably refers to ASTM D1894 static friction coefficient. Then optionally, the second protective film (such as the bottom film) is removed, and a second catalyst layer is coated on the second surface of the substrate to form a double-sided CCM. Due to the existence of the new protective layer with a friction coefficient in a specific range, the present invention is particularly suitable for a direct coating method that can achieve better CCM performances and have a relatively simple process. The reasons are that the present invention will not have the conventional defects such as the electrolyte membrane deformation and the surface swelling that are easily caused by a large amount of solvent contacting the electrolyte membrane during the process of preparing CCM by a direct coating method; and the present invention does not require additions of other process steps (such as additional solvent removal procedures) or equipment (such as a vacuum suction equipment) in order to use the direct coating method. In addition, indirect coating methods (such as the transfer printing method) can also be applied in the present invention for producing a CCM with flat surfaces without swelling.

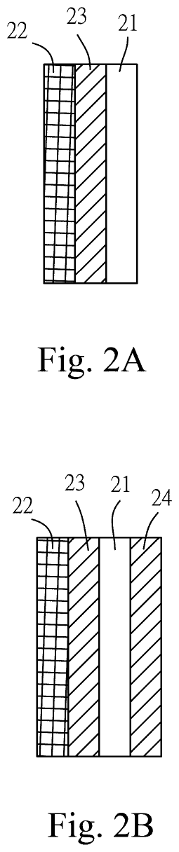

Please refer to FIGS. 2A and 2B, which respectively show a single-sided CCM and a double-sided CCM made according to the flow chart of FIG. 1. As shown in FIGS. 2A and 2B, both the single-sided CCM and the double-sided CCM contain a sandwich structure as shown in FIG. 2A. The sandwich structure includes a first substrate 21, a second substrate 22, and a first catalyst layer 23 sandwiched between the first substrate 21 and the second substrate 22, wherein the second substrate 22 has a friction coefficient in the range of 2 to 15, preferably in the range of 5 to 15, and more preferably in the range of 10 to 15. Preferably, the second substrate 22 includes at least one of the following materials: silicone, rubber, silicone rubber and polymer. Preferably, the sandwich structure is a sandwich structure laminated under a membrane pressure. As shown in FIG. 2B, in addition to the sandwich structure of the double-sided CCM, a second catalyst layer 24 is also provided on the surface of the first substrate 21. In the example shown in FIG. 2B, the first catalyst layer 23 and the second catalyst layer 24 have the same composition. However, in other embodiments, the first catalyst layer 23 and the second catalyst layer 24 may have different compositions.

In some embodiments, the catalyst coating method for a gas reaction includes the following steps. First, a sandwich structure is provided. The sandwich structure comprises a first substrate, a second substrate, and a catalyst layer sandwiched between the first substrate and the second substrate, wherein the second substrate has a friction coefficient ranging from 2 to 15, preferably ranging from 5 to 15, and more preferably ranging from 10 to 15. For example, the sandwich structure may be provided in the manner described in the steps S1 to S3 in FIG. 1. Next, the sandwich structure is laminated together with a pressure in a range of greater than 0 Kgf/cm² and less than or equal to 380 Kgf/cm², preferably in a range of greater than 0 Kgf/cm² and less than or equal to 50 Kgf/cm², and more preferably in a range of greater than 0 Kgf/cm² and less than or equal to 10 Kgf/cm². Then, optionally, another catalyst layer is configured on the surface of the first substrate, so that the catalyst layer and the other catalyst layer are respectively disposed on two opposite surfaces of the first substrate.

### Embodiment 1

This embodiment provides a CCM manufacturing method according to the present invention. The method uses the direct coating technology of scrape coating and mainly comprises a first catalyst layer coating process, a lamination process and a second catalyst layer coating process, which are detailed as follows.

First, the first catalyst slurry and the second catalyst slurry with the material ratio in Table 1 are prepared.

TABLE 1
Material ratio of the first catalyst slurry and
the second catalyst slurry in Embodiment 1.

| | Catalyst | Binder | Dispersant | Sum |
|---|---|---|---|---|
| Weight | 0.1 g | 4 g | 6 g | 10.1 g |
| Ratio (wt %) | 0.99% | 39.6% | 59.41% | 100% |

### First Catalyst Layer Coating Process

The first substrate (which is the electrolyte membrane Nafion 212) with the cover film and the bottom film is unrolled, and the cover film is peeled off to expose the first surface of the electrolyte membrane where the bottom film still covers the second surface. A scrape coating mold having a thickness of 0.1 mm was configured on the first surface of the electrolyte membrane and heated to a coating temperature of 70° C. The scrape coating of the first catalyst slurry is performed directly on the first surface of the electrolyte membrane with a first catalyst slurry titration amount of 0.5 cc and a scrape spacing of 0.1 mm at a scrape coating speed of 1 mm/second to form a first catalyst layer with a size of 2.5 cm×2.5 cm and a thickness of 30 μm on the first surface of the electrolyte membrane. Next, the first catalyst layer is dried at a temperature of 70° C. to at least partially evaporate the solvent in the first catalyst layer. It can be observed that the surface of the dried first catalyst layer is flat and the electrolyte membrane does not have any swelling or deformation conditions.

### Lamination Process

The first catalyst layer is laminated to the second substrate (which is a silicone membrane with an ASTM D1894 static friction coefficient of 13.78) under the following lamination conditions to produce a single-sided CCM: a room temperature environment, a membrane pressure of 0.288 Kgf/cm², a 1.8 Kg heavy object, a 760 torr air pressure, 30 minutes of a lamination time. It can be observed that the surface of the single-sided CCM after lamination is flat without any swelling or deformation.

### Second Catalyst Layer Coating Process

The bottom film is peeled off to expose the second surface of the electrolyte membrane. A scrape coating mold having a thickness of 0.1 mm was configured on the second surface of the electrolyte membrane and heated to a coating temperature of 70° C. The scrape coating of the second catalyst slurry is performed directly on the second surface of the electrolyte membrane with a second catalyst slurry titration amount of 0.5 cc and a scrape spacing of 0.1 mm at a scrape coating speed of 1 mm/second to form a second catalyst layer with a size of 2.5 cm×2.5 cm and a thickness of 30 μm on the second surface of the electrolyte membrane. Next, the second catalyst layer is dried at a temperature of 70° C. to at least partially evaporate the solvent in the second catalyst layer. Finally, the produced double-sided CCM is rolled up. It can be observed that the surfaces of the dried second catalyst layer and the overall double-sided CCM are flat without any swelling or deformation.

### Embodiment 2

This embodiment uses second substrates with different friction coefficients to prepare the double-sided CCMs of Examples 1 to 5 based on the manufacturing methods of the present invention. The manufacturing method uses the direct coating technology of scrape coating and mainly comprises a first catalyst layer coating process, a lamination process and a second catalyst layer coating process.

First, the first catalyst slurry and the second catalyst slurry with the material ratio in Table 2 are prepared.

TABLE 2
Material ratio of the first catalyst slurry and
the second catalyst slurry in Embodiment 2.

| | Catalyst | Binder | Dispersant | Sum |
|---|---|---|---|---|
| Weight | 1.8 g | 8 g | 4 g | 13.8 g |
| Ratio (wt %) | 13.04% | 57.97% | 28.99% | 100% |

The first catalyst layer coating process is carried out in a manner the same as that in Embodiment 1. It can be observed that the surface of the dried first catalyst layer is flat and the electrolyte membrane does not have any swelling or deformation conditions.

### Lamination Process

The first catalyst layer is laminated to the second substrate (which is one of the silicone membrane samples 1 to 5 with ASTM D1894 static friction coefficients as defined in Table 3) under the following lamination conditions to produce a single-sided CCM: a room temperature environment, a membrane pressure of 0.288 Kgf/cm², 1.8 Kg of a heavy object, a −760 torr air pressure, 30 minutes of a lamination time. It can be observed that the surfaces of the single-sided CCMs after lamination are flat without any swelling or deformation.

The second catalyst layer coating process is carried out in a manner the same as that in Embodiment 1. After observation, the surface states of the produced double-sided CCMs are described in Table 3.

TABLE 3
Static friction coefficients of the second substrates and
surface states of the double-sided CCM Examples 1 to 5

| | Double-sided CCMs | | | | |
|---|---|---|---|---|---|
| | Example 1 | Example 2 | Example 3 | Example 4 | Example 5 |
| Second | Sample 1 | Sample 2 | Sample 3 | Sample 4 | Sample 5 |
| substrates | | | | | |
| Static friction | 0.115 | 1.076 | 6.55 | 7.79 | 13.748 |
| coefficients of | | | | | |
| second | | | | | |
| substrates | | | | | |
| (ASTM D1894) | | | | | |
| Membrane | 1.288 | 1.288 | 1.288 | 1.288 | 1.288 |
| Pressure | | | | | |
| (Kgf/cm²) | | | | | |
| Surface states of | Swelling | Swelling | Flat surface | Flat surface | Flat surface |
| double-sided | Bulges | Bulges | No swelling, | No swelling, | No swelling, |
| CCMs | | Big creases | bulges or | bulges or | bulges or |
| | | | creases | creases | creases |

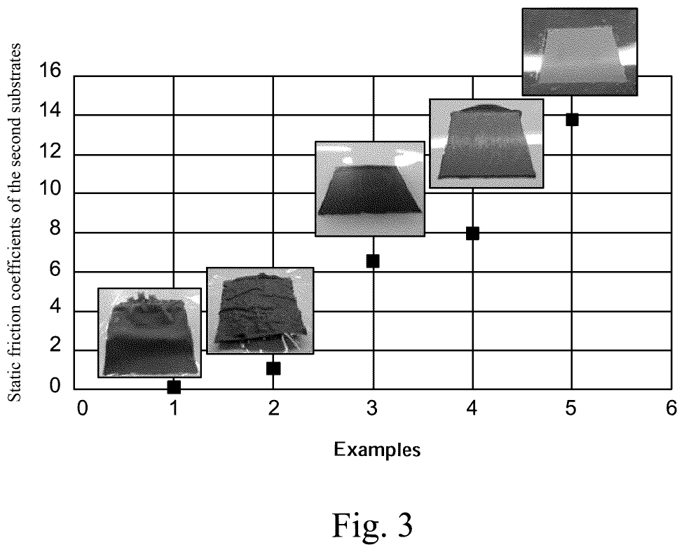

Please refer to FIG. 3, which shows the influence of different static friction coefficients of the second substrate samples 1 to 5 on the surface flatness of the CCMs in Examples 1 to 5. As shown in this figure, the greater the static friction coefficient of the second substrate, the better the surface flatness of the double-sided CCM produced, and there is an obvious positive correlation between the two. In particular, when the static friction coefficient of the second substrate is less than 2 (for example, the second substrate samples 1 and 2 in Examples 1 and 2 in Table 3), the double-sided CCMs made with such second substrates have obvious surface swelling and bulging issues.

### Embodiment 3

In this embodiment, the double-sided CCMs of Examples 6 to 9 with different catalyst layer thicknesses are produced based on the manufacturing methods of the present invention. The manufacturing method mainly includes a first catalyst layer coating process, a lamination process and a second catalyst layer coating process, which are similar to those in Embodiment 1. The difference between Embodiment 3 and Embodiment 1 is that Embodiment 3 uses molds with different thicknesses as defined in Table 4 to manufacture double-sided CCMs with first/second catalyst layers of different thicknesses. The overall surface states of the manufactured double-sided CCMs are described in Table 4. The thickness of the coated catalyst layer increases with the increase in mold thickness, as shown in Table 4. In Examples 6 to 9, molds with a thickness in a range of 100 to 400 μm are used, respectively. In order to form a thick coating layer, more catalyst layer slurry will be supplied onto the electrolyte membrane, and therefore the electrolyte membrane will inevitably be exposed to a larger amount of the coating solvent at one time. It can be seen from the surface state results in Table 4 that even catalyst layer thicknesses as high as 61 and 76.3 μm (refer to Example 9) will not cause any unevenness defects on the CCM surface. Therefore, the method of the present invention will not cause surface wrinkles or swelling of the CCMs due to an increase in the amount of the solvent applied during a single coating process.

TABLE 4
Mold thickness used to manufacture the double-sided CCMs of Examples
6 to 9 and first/second catalyst layer thicknesses and surface
states of the double-sided CCMs of Examples 6 to 9

| | | Example 6 | Example 7 | Example 8 | Example 9 |
|---|---|---|---|---|---|
| Mold thickness (μm) | | 100 | 200 | 300 | 400 |
| First | Thickness | 17 | 37.3 | 41.3 | 61 |
| catalyst | (μm) | | | | |
| layer | Surface state | Flat surface | Flat surface | Flat surface | Flat surface |
| | | No swelling, | No swelling, | No swelling, | No swelling, |
| | | bulges or | bulges or | bulges or | bulges or |
| | | creases | creases | creases | creases |
| Second | Thickness | 17.6 | 36.6 | 60 | 76.3 |
| catalyst | (μm) | | | | |
| layer | Surface state | Flat surface | Flat surface | Flat surface | Flat surface |
| | | No swelling, | No swelling, | No swelling, | No swelling, |
| | | bulges or | bulges or | bulges or | bulges or |
| | | creases | creases | creases | creases |

The method of the present invention can solve the two major problems of difficulty in flattening and holding the substrate when forming the catalyst layers of CCMs and the swelling effect caused by a large amount of the solvent contacting the substrate. In the present invention, coating is performed at a coating temperature higher than a room temperature during the manufacturing process, so that the formed catalyst layer has a flat surface. In addition, a second substrate with a high friction coefficient is used in the present invention to manufacture CCMs in such a way that the second substrate with the high friction coefficient adheres and holds the extremely thin first substrate, so that the structure of the first substrate will not be damaged, stretched, deformed or wrinkled during the CCM manufacturing process. CCMs with flat surfaces can be manufactured without the need for hot pressing or other additional processes that make the CCM manufacturing process more complex (such as additional processes traditionally added to overcome defects caused by direct coating methods, such as a solvent removal processes). Therefore, the present invention is especially applicable to the direct coating methods to produce single-sided CCMs or double-sided CCMs with flat surfaces under the fewest process restrictions, thereby achieving high-efficiency industrial productions. In addition, even if the method of the present invention is used to directly coat a thick catalyst layer, a CCM with a flat surface can also be manufactured, which avoids the problems of low production efficiency and low yield caused by multiple coating and drying processes in an indirect coating manufacturing process.

This invention is truly an innovative invention with profound industrial value, and the application must be filed in accordance with the law. In addition, the present invention may be modified in any way by those with ordinary skill in the art without departing from the scope of protection as claimed in the appended patent application.

1. A method for manufacturing a catalyst-coated membrane for a gas reaction, comprising:
providing a first substrate having a first surface;
forming a first catalyst layer on the first surface of the first substrate;
providing a second substrate with a friction coefficient ranging from 2 to 15 on the first catalyst layer; and
laminating the first catalyst layer onto the second substrate with a membrane pressure to form the catalyst-coated membrane, wherein the membrane pressure ranges greater than 0 Kgf/cm² and less than or equal to 380 Kgf/cm².

2. The method as claimed in claim 1, wherein the first substrate is one of a high molecular membrane and an electrolyte membrane.

3. The method as claimed in claim 1, further comprising:
heating the first substrate to a coating temperature.

4. The method as claimed in claim 3, further comprising:
forming the first catalyst layer at the coating temperature.

5. The method as claimed in claim 1, wherein the friction coefficient is a static friction coefficient ranging from 5 to 15, and the membrane pressure ranges greater than 0 Kgf/cm² and less than or equal to 50 Kgf/cm².

6. The method as claimed in claim 1, wherein the friction coefficient is a static friction coefficient ranging from 10 to 15, and the membrane pressure ranges greater than 0 Kgf/cm² and less than or equal to 10 Kgf/cm².

7. The method as claimed in claim 1, wherein the second substrate comprises a polymer.

8. The method as claimed in claim 7, wherein the polymer comprises at least one of a silicone, a rubber and a silicone rubber.

9. The method as claimed in claim 1, wherein the laminating step is performed in a vacuum environment.

10. The method as claimed in claim 1, wherein the first substrate has a second surface opposite to the first surface, and the method further comprises:
heating the first substrate to a coating temperature; and
forming a second catalyst layer on the second surface of the first substrate at the coating temperature.

11. The method as claimed in claim 10, wherein at least one of the first catalyst layer and the second catalyst layer is formed by a roll-to-roll (R2R) coating method, a brush coating method, an ultrasonic coating method, a scrape coating method, a transfer printing method, or a screen printing method.

12. The method as claimed in claim 11, wherein at least one of the first catalyst layer and the second catalyst layer is formed by a direct coating method.

13. A method for manufacturing a catalyst-coated membrane for a gas reaction, comprising:
providing a sandwich structure including a first substrate, a second substrate and a first catalyst layer sandwiched between the first substrate and the second substrate, wherein the second substrate has a friction coefficient ranging from 2 to 15; and
laminating the sandwich structure together with a pressure ranging greater than 0 Kgf/cm² and less than or equal to 380 Kgf/cm².

14. The method as claimed in claim 13, wherein providing the sandwich structure comprises:
providing the first substrate having a first surface, a second surface opposite to the first surface, a first protective film for protecting the first surface, and a second protective film for protecting the second surface;
removing the first protective film;
coating the first catalyst layer on the first surface of the first substrate; and
covering the first catalyst layer with the second substrate to form the sandwich structure.

15. The method as claimed in claim 14, wherein the sandwich structure further comprises a second catalyst layer so that the first substrate is sandwiched between the first catalyst layer and the second catalyst layer, and the method further comprises:
removing the second protective film; and
coating the second catalyst layer on the second surface of the first substrate to form the sandwich structure.

16. The method as claimed in claim 14, wherein the first substrate is one of a high molecular membrane and an electrolyte membrane, the second substrate has a friction coefficient ranging from 5 to 15, the pressure ranges greater than 0 Kgf/cm² and less than or equal to 50 Kgf/cm², the sandwich structure is laminated together in a vacuum environment, and the method further comprises:
heating the first substrate to a coating temperature; and
coating the first catalyst layer on the first surface of the first substrate at the coating temperature.

17. The method as claimed in claim 15, wherein the second substrate has a friction coefficient ranging from 10 to 15, the pressure ranges greater than 0 Kgf/cm² and less than or equal to 10 Kgf/cm², the sandwich structure is laminated together in a vacuum environment, and the method further comprises:
heating the first substrate to a coating temperature; and
coating the second catalyst layer on the second surface of the first substrate at the coating temperature.

18. A catalyst-coated membrane for a gas reaction, comprising:
a first substrate;
a second substrate having a friction coefficient ranging from 2 to 15 and including a polymer; and
a catalyst layer sandwiched between the first substrate and the second substrate.

19. The catalyst-coated membrane as claimed in claim 18, wherein the friction coefficient is a static friction coefficient ranging from 5 to 15, and the first substrate is one of a high molecular membrane and an electrolyte membrane.

20. The catalyst-coated membrane as claimed in claim 18, wherein the friction coefficient is a static friction coefficient ranging from 10-15, and the polymer comprises at least one of a silicone, a rubber and a silicone rubber.
